(19) United States
(12) Patent Application Publication
(10) Pub. No.: US 2009/0019743 A1
(43) Pub. Date: Jan. 22, 2009

(54) BEHIND C-CHANNEL SHELF ATTACHMENT MECHANISM

(76) Inventor: Long Van Nguyen, San Jose, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/780,103

(22) Filed: Jul. 19, 2007

(51) Int. Cl. G09F 11/00

(52) U.S. Cl. 40/508

(57) ABSTRACT

A spring clip clamps tightly behind the shelf C-Channel. An adapter attaches onto the spring clip with a spring catch. An ESL attaches to the front of the adapter with a spring catch. An included tool facilitates both the removal of the ESL from the adapter and the removal of the adapter from the spring clip.

### FIELD OF THE INVENTION

The present disclosure relates to Electronic Shelf Labels (ESL) and, more particularly, to systems and methods that facilitate installment and removal of ESLs to and from retail store shelves.

### BACKGROUND OF THE INVENTION

Electronic Shelf Labels are becoming increasingly popular amongst large retail stores. These ESLs are replacing the traditional paper and plastic labels. Most current display shelves are of the C-Channel type where the traditional paper and plastic tags can snap into. ESLs are larger and heavier than the paper and plastic labels that they replace and therefore require a different attachment mechanism. Prior attachment mechanisms for ESLs have been expensive, unreliable, or difficult to install or remove. In light of those disadvantages, there is a need for an inexpensive and reliable device for mounting ESLs to existing C-Channel shelves that is easy to both install and remove.

### SUMMARY

The following describe systems and methods that facilitate the attachment and removal of Electronic Shelf Labels to the common C-Channel type shelves present in retail stores in a manner that is economical, universal, reliable, and easy to install and remove. In a preferred embodiment, a spring clip clamps securely onto the rear of the shelf C-Channel. An adapter attaches onto the spring clip with a spring catch. An ESL attaches to the front of the adapter with a spring catch. An included tool facilitates both the removal of the ESL from the adapter and the removal of the adapter from the spring clip.

Other aspects and features of this preferred embodiment of the invention will become apparent with consideration of the following description along with the accompanying drawings.

### BRIEF DESCRIPTION OF THE DRAWINGS

FIG. 1 is a side view of an ESL, adapter and spring clip installed onto a typical C-Channel type shelf.

FIG. 2 is a side oriented perspective view of an exploded assembly of the ESL, adapter, and spring clip along with a typical C-Channel shelf.

FIG. 3 is a bottom oriented perspective of an exploded assembly of the ESL, adapter, and spring clip along with a typical C-Channel shelf.

FIG. 4 is a front oriented perspective view of the adapter and spring clip installed onto a typical C-Channel shelf.

FIG. 5a is front oriented perspective view of the adapter mounted onto the spring clip without the C-Channel type shelf present.

FIG. 5b is a front oriented perspective view of the adapter aligned with the spring clip before being mounted on the clip.

FIG. 6 is a side oriented perspective view of the spring clip clamped onto a typical C-Channel shelf.

FIG. 7a is a rear oriented perspective view of the adapter mounted onto the spring clip and the ESL mounted onto the adapter.

FIG. 7b is a rear oriented perspective view of an exploded assembly of the adapter aligned with the spring clip before being mounted on the clip.

FIG. 8 is a side oriented perspective view of the ESL, adapter, and spring clip installed onto a typical C-Channel shelf along with the removal tool.

FIG. 9 is a side oriented perspective view of the ESL, adapter, and spring clip installed onto a typical C-Channel type shelf and shown with the removal tool being used to remove the ESL from the adapter.

FIG. 10 is a front oriented perspective view of the ESL being removed from the adapter using the removal tool.

FIG. 11 is a rear oriented perspective view of the adapter being removed from the spring clip using the removal tool.

FIG. 12 is a front view of the adapter being removed from the spring clip using the removal tool.

Note that the figures are not drawn to scale and that elements of similar structures or functions are generally represented by like reference numerals for illustrative purposes throughout the figures. Also note that the figures are only intended to facilitate the description of the preferred embodiments. The figures do not describe every aspect of the present invention and do not limit the scope of the invention.

### DETAILED DESCRIPTION OF THE PREFERRED EMBODIMENTS

Each of the additional features and teachings disclosed below can be utilized separately or in conjunction with other features and teachings to provide an attachment mechanism for a C-Channel shelf. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

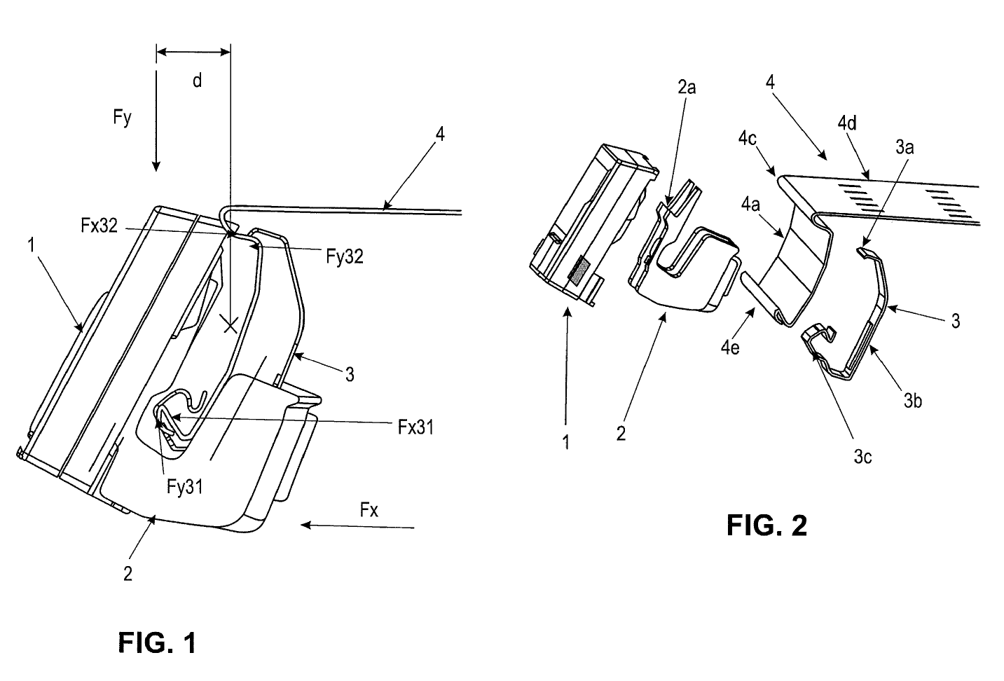

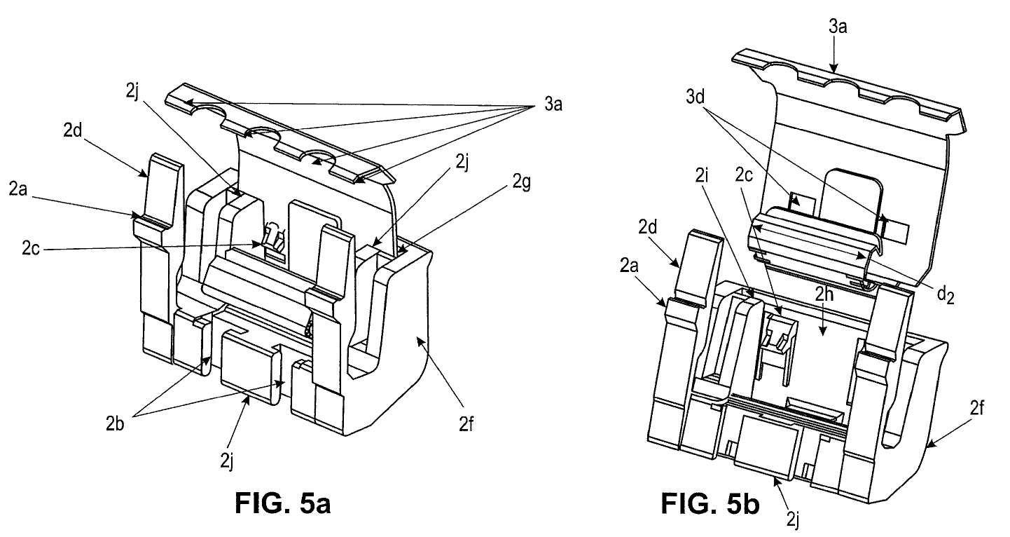

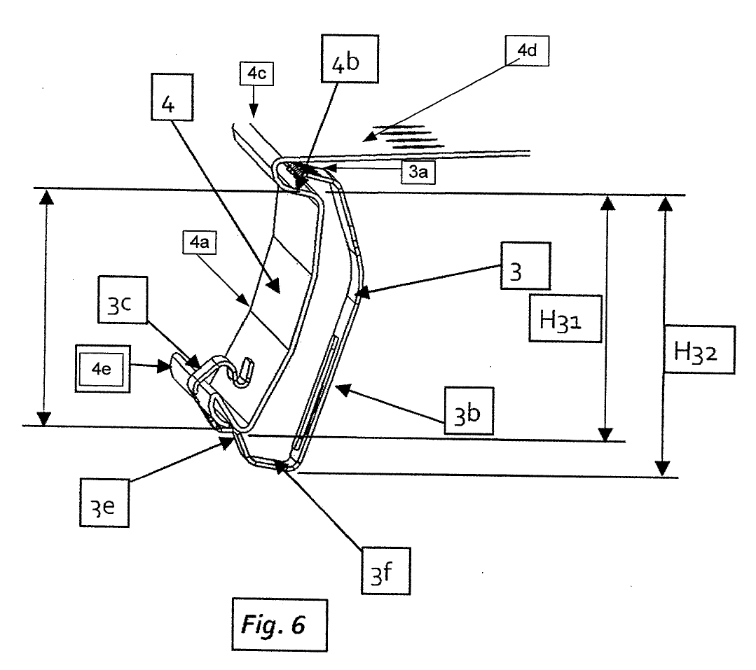

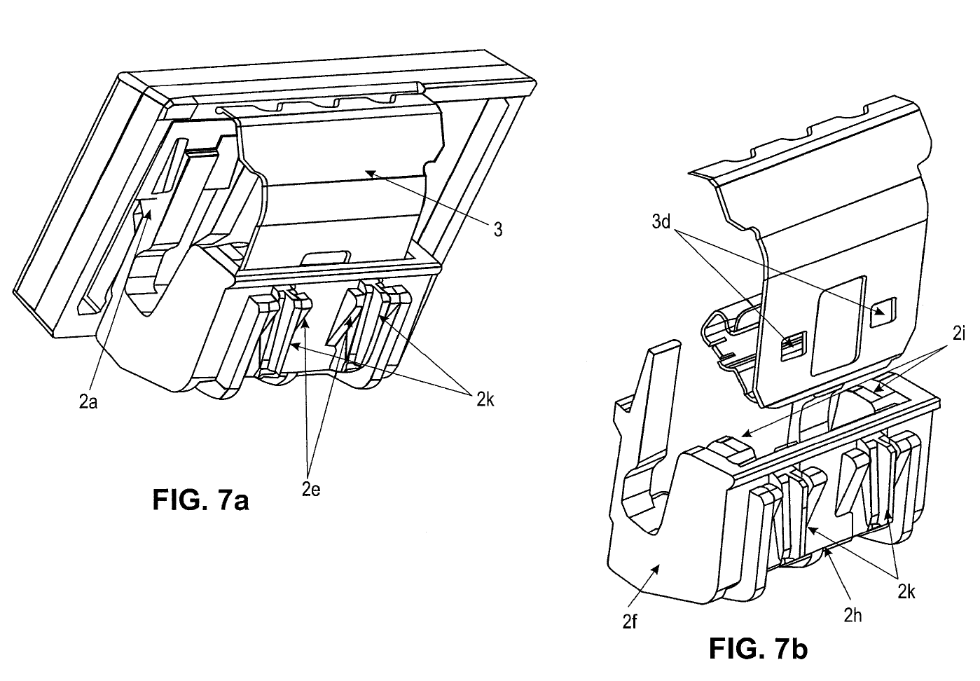

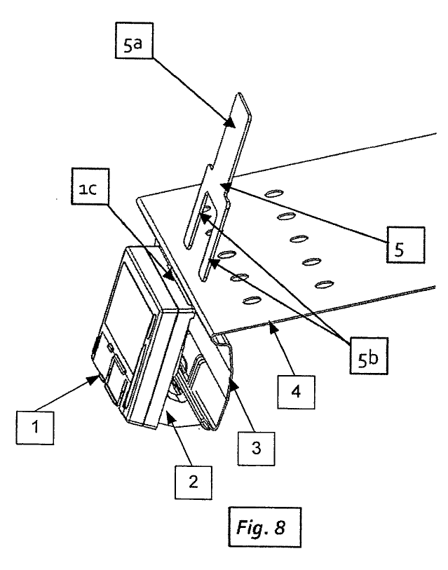

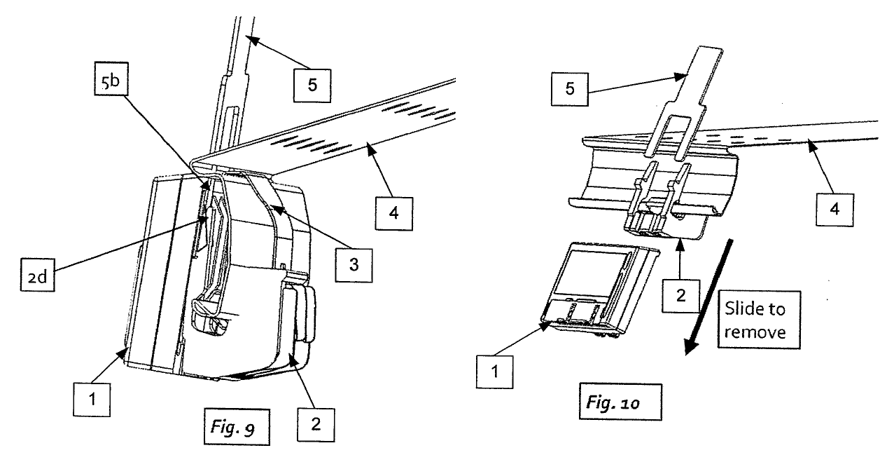

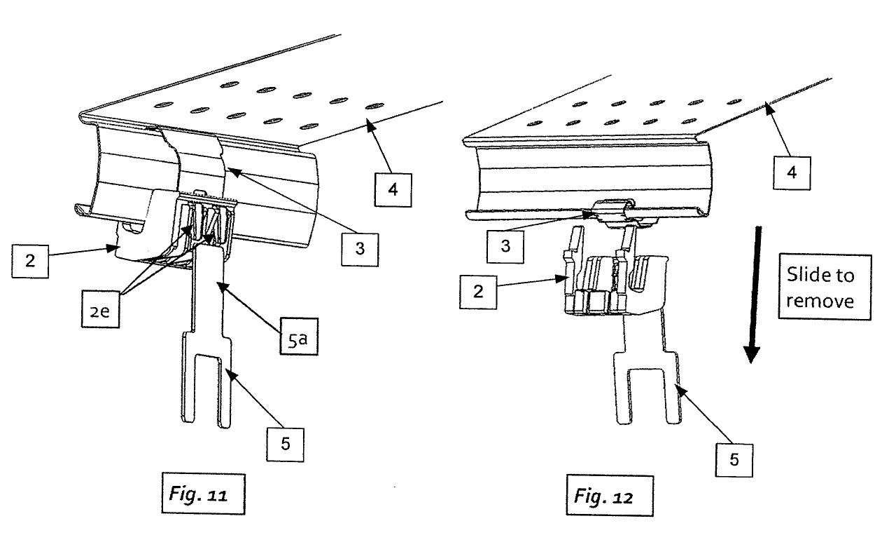

Turning to the figures, an exemplary embodiment of a C-channel shelf attachment mechanism will now be described. As depicted, the attachment mechanism includes an adapter 2 and spring clip 3 for mounting an Electronic Shelf Label (ESL 1) 1 onto a typical C-Channel type shelf 4. The spring clip 3, as shown in FIGS. 1 and 6, clamps tightly to the C-Channel type shelf 4. The adapter 2, shown in FIGS. 5a, 5b, 7a, and 7b, releasably attaches to the spring clip 3 and is retained in place on the spring clip 3 with a retainer mechanism comprising a pair of spring catches 2c. The ESL 1, as depicted in FIGS. 1, 2, and 3, attaches to the front of the adapter 2. A removal tool 5, shown in FIGS. 8-12, is used to separate the ESL 1 from the adapter 2.

The attachment mechanism is preferably designed to fit onto most conventional C-Channel type store shelves 4. The C-Channel store shelves 4 commonly comprise a horizontal plane 4d on which products are placed for customer viewing. The C-Channel shelf 4 has a shallow “C” shaped holder or channel 4a, as shown in FIG. 2, that extends below the front edge 4c of the horizontal plane 4d. The front edge 4c of the plane 4d and the lower end 4e of the “C” shaped holder 4a are preferably radiused. At the lower end 4e, the “C” shaped holder 4a folds over onto itself. Traditional, non-electronic shelf labels, such as paper or plastic labels, snap securely inside of that “C” shaped holder 4a. However, ESLs 1 typically do not fit in the “C” shaped holder 4a of the C-Channel shelves 4 in the manner of those traditional shelf labels.

The spring clip 3 is preferably formed from a rectangular strip of metal bent into a generally “G” shape. Alternately, the clip 3 can be formed from plastic or other materials having appropriate strength using conventional technology, such as extrusion, injection molding, and the like. The material should be flexible with spring like properties that allow the jaws, i.e., the top end 3a and bottom end 3c of the clip 3 to stretch open for installation or removal and tighten or clamp down once in position. Referring to FIGS. 5a, 5b and 6, the top end 3a of the clip 3 preferably includes a plurality of claws 3g or fingers, preferably with sharpened ends to enable the claims 3g to dig into, bite, or grab the top 4b of the “C” shaped holder 4a from behind. The lower end 3c of the clip 3 curves around the bottom end 4e of the “C” shaped holder 4a, discouraging the clip 3 from coming loose. The clip 3 includes a well feature 3f in the lower end that is sized to rotatably receive the bottom end 4e of the “C” shaped holder 4a. As depicted in FIG. 5b, lower end 3c of the clip 3 is cut narrower in width d₂ than the rest of the clip 3. As depicted in FIGS. 4, 5b, and 7b, two small square holes 3d on the middle of the clip 3 allow spring catches 2c of the adapter 2 component to releasably engage the clip 3.

Installation of the spring clip 3 onto the C-Channel shelf 4: Referring to FIG. 6, the well feature 3f of the spring clip 3 is placed around the bottom 4e of the “C” shaped holder 4a. With the well feature 3f in place, the top portion 3a of the clip 3 will have room to swing. The top jaw 3a of the spring clip 3 is placed against the top 4b of the “C” shaped holder 4a. Next, the spring clip 3 is pushed inwardly against the bottom portion 4e of the “C” shaped holder 4a until the detent feature 3e of the spring clip 3 slides over the folded portion and locks against the bottom 4e of the “C” shaped holder 4a. Since the length H₃₁ is smaller than length H₃₂, the bottom 4e portion of the “C” shaped holder 4a is held in place against the detent 3e of the clip 3 by spring force. Upon completion, the installed spring clip 3 should look like FIG. 6.

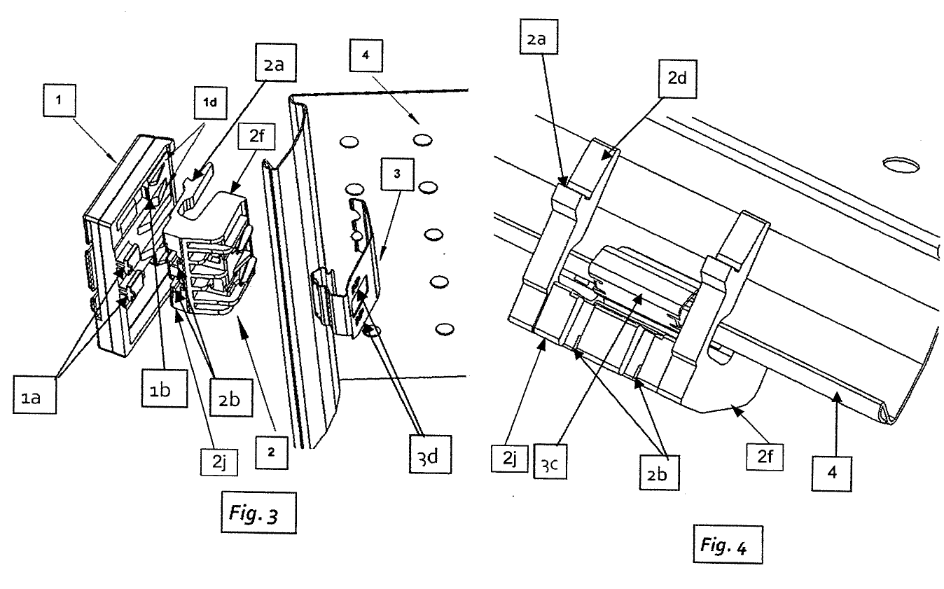

Referring to FIGS. 3, 5a, 5b, 7a, and 7b, the adapter 2 comprises a back panel 2h and a base 2j extending between two side panels 2f. The two opposing side 2f panels are generally “J” shaped. Two guides 2i extend inward from the entire height of each side panel 2f and in spaced relation with the back panel 2h. The resulting channel or keyway 2g, formed between the back panel 2h, the two side panels 2f, and the two guides 2i, is just large enough to allow the body 3b of the spring clip 3 to slide through. When the spring clip 3 is positioned inside the channel 2g, its motion is limited to only slide up or down. The back panel 2h features two small spring latches 2c that snap into the two small square holes or catches 3d in the middle of the spring clip body 3b, releasably locking the adapter 2 and the spring clip 3 together. The spring latches 2c are operated on the back panel 2h.

Two cams 2e lie to each side of those spring latches to guide the removal tool 5 as it slides under the removal tabs 2k of the spring latches 2c to draw the latches outward to disengage the spring latches 2c from the catches 3d on the spring clip 3. Two keyways 2b are cut into the front of the base 2j that are slidably engaged by two corresponding ESL keys 1a. Two pillars or mounting arms 2d extend up from the bottom-front of the side panels 2f. A pair of latches 2a extending from and facing forward on each pillar 2d facilitate attachment of the ESL 1 to the adapter 2. The pillars 2d are flexible enough to allow them to bend slightly to releasably lock their latches 2a in place on to the ESL 1.

Installation of the adapter 2 onto the spring clip 3: First, the channel or keyway 2g on the adapter 2 is aligned with the spring clip body 3b as depicted in FIGS. 5b and 7b. Next, from below, the adapter 2 is slid up around the spring slip 3 vertically from below until it is locked into position. The adapter springs latches 2c to catch the holes or catches 3d on the spring clip 3. Completion of the adapter 2 installation on the spring clip 3 is depicted in FIGS. 4, 5a and 7a.

The ESL 1 unit comprises a body with a display device. Toward the bottom of the back of the ESL 1, two mounting keys 1a extend out from the body. The mounting keys 1a are preferably cross-shaped when viewed from below. The mounting keys 1a slide through the correspondingly shaped keyways 2b on the adapter 2. When the keys 1a on the ESL 1 are inside the keyways on the adapter 2, the ESL 1's motion is limited to only slide up or down. To lock the ESL 1 to the adapter 2, the ESL 1 includes two indentations or catches 1b that correspond to the two latches 2a on the two pillars or mounting arms 2d of the adapter 2. Slightly above each of those indentations 1b are two ramp features 1d. During removal of the ESL 1, these ramps 1d allow the removal tool 5 to slide down on them from above to push the pillar latches 2a on the adapter 2 out of the indentations 1b on the ESL 1.

Installation of the ESL 1 onto the adapter 2: Referring to FIG. 3, the ESL 1 keys 1a are first aligned with the keyways 2b on the adapter 2. Next, from below, the ESL 1 is slid up until the latches 2a on the pillars 2d engage the indentations 1b on the ESL 1 and lock into position. The pillar latches 2a on the adapter 2 should snap onto the ESL 1 indentations 1b. Next, a slight downward push on the ESL 1 will fully engage the pillar latches 2a.

The removal tool 5 is a square “Y” shaped plate made preferably of either plastic or metal. It consists of two narrow prongs 5b on one end and a wider prong 5a on the other end. The two-pronged end is used to separate the ESL 1 from the adapter 2. The single-pronged end is used to separate the spring clip 3 from the adapter 2.

The mechanism must withstand vertical Fy and horizontal Fx forces as depicted in FIG. 1. A vertical Fy force comes from the weight of products being removed from the shelf. The mechanism might have to bear the entire weight of a product of as much as 50 lbs. A horizontal Fx force comes from incidental contact from products being removed from below the shelf 4. The vertical Fy forces are generally larger and more likely to detach most other attachment mechanisms. As more vertical Fy force is placed on the attachment mechanism, the spring clip 3 advantageously clamps tighter onto the “C” shaped holder 4a. This self-locking effect makes the attachment mechanism very resistant to accidental detachment.

Since only the spring clip 3 makes contact with the shelf 4, all forces placed on any part of the attachment mechanism are transferred to the points of contact where the top 3a of the clip 3 meets the top of 4b of the “C” shaped holder 4a and where the detent 3e of the bottom 3c of the clip 3 meets the bottom 4e of the “C” shaped holder 4a. Fx and Fy forces are therefore transferred to Fx31, Fy31, Fx32 and Fy32 at the points of shelf contact in FIG. 1. The vertical Fy force also creates a rotational load M, which equals Fy*d₁. d is the distance from the load to the pivot point. The pivot point is where the top jaw 3a of the spring clip 3 meets the “C” shaped holder 4a.

Removal of the ESL 1 attachment mechanism:

Referring to FIGS. 3, 8, 9, and 10, removal of the ESL 1 from the adapter 2 is shown: First, the ESC 1 is slid slightly upward. Next, the two pronged end 5b of the removal tool 5 is slid through the slot opening 1c down to engage the ESL ramps 1d until the adapter latch 2a clears the ESL catch 1b. Next, the ESL 1 is slid downward until it is free from the adapter 2.

Referring to FIGS. 7a, 7b, 11, and 12, removal of the adapter 2 from the spring clip 3 is shown: First, the adapter 2 is pushed slightly upward. Next, the single pronged end 5a of the removal tool 5 is slid through the opening formed by the adapter cam 2e and the adapter spring latches 2c. The adapter 2 will be free from the spring clip 3 when the adapter spring latches 2c disengage from the square holes 3d on the spring clip 3.

Remove the spring clip 3 from the shelf 4 by reversing the installation steps of attaching the spring clip 3 to the shelf 4.

The embodiment disclosed above is only one of many functional forms. Other embodiments might join the ESL 1 to the adapter 2 and the adapter 2 to the metal clip via other methods. Latches, springs, and catches on the ESL 1, adapter 2 and the spring clip 3 may be substituted by other devices for the function of joining two pieces together. The adapter 2 may take different materials, shapes, and sizes to implement those other devices. Also, it is possible to forego the adapter 2 completely by attaching the ESL 1 directly to the spring clip 3 without the adapter 2.

Those skilled in the art will recognize that the embodiments disclosed herein are susceptible to various modifications and alternative forms, and specific examples thereof have been shown by way of example in the drawings and are herein described in detail.

What is claimed is:

1. An electronic shelf label system for attachment to C-Channel type shelves comprising
a clip having a body with first and second opposing jaws that engage the top and bottom of a c-shaped holder of a c-channel shelf to fix the clip relative to the c-channel self,
an adapter having a channel to releasably receive the body of the clip and a latch that releasably engages a catch formed in the body of the clip, and
an electronic shelf label (ESL) having a body housing a display, the body of the ESL being releasably coupled to the adapter.

2. The ESL system of claim 1 wherein the first opposing jaw at a top end of the clip comprising a plurality of claws to engage the top end of the c-shaped holder.

3. The ESL system of claim 1 wherein the second opposing jaw includes a detent at a bottom end of the clip to engage the bottom end of the c-shaped holder.

4. The ESL system of claim 3 wherein the second end of the clip further comprising a well sized to receive the bottom end of the c-shaped holder during install of the clip on the c-shaped holder.

5. The ESL system of claim 1 wherein the catch comprises one or more holes formed in the body of the clip.

6. The ESL system of claim 5 wherein the latch of the adapter include one or more spring like tabs.

7. The ESL system of claim 6 wherein the adapter includes one or more cam members adjacent each of the one or more tabs.

8. The ESL system of claim 1 wherein the bottom end of the clip is narrower than the remainder of the clip.

9. The ESL system of claim 1 wherein the body of the adapter comprising first and second panels, a base and a back panel, the base and back panel extending between the side panels.

10. The ESL system of claim 9 further comprising first and second guides coupled to the side panels and in spaced relation with the back panel, the first and second guides, first and second side panels, and back panel forming the channel.

11. The ESL system of claim 1 further comprising one or more keyways cut into the base of the adapter and one or more keys extending from the body of the ESL and releasably received in the keyways.

12. The ESL system of claim 1 further comprising first and second mounting arms extending upward from the base and side panels, the first and second mounting arms each including a latch to engage first and second catches on the body of the ESL.

13. An attachment mechanism for attaching an electronic shelf label (ESL) to a C-Channel type shelve comprising
a clip having a body with upper and lower ends, the lower end having an inwardly protruding detent to engage the bottom of a c-shaped holder of a c-channel shelf and the upper end having a claw to engage the top of the c-shaped holder, and
an adapter having a latch that releasably engages a catch formed in the body of the clip, the adapter being adapted to releasably engage an ESL.

14. The attachment mechanism of claim 13 wherein the claw of the upper end of the clip comprising a plurality of fingers to engage the top end of the c-shaped holder.

15. The attachment mechanism of claim 13 wherein the lower end of the clip further comprising a well sized to receive the bottom end of the c-shaped holder during install of the clip on the c-shaped holder.

16. The attachment mechanism of claim 13 wherein the catch comprises one or more holes formed in the body of the clip.

17. The attachment mechanism of claim 16 wherein the latch of the adapter include one or more spring like tabs.

18. The attachment mechanism of claim 17 wherein the adapter includes one or more cam members adjacent each of the one or more tabs.

19. The attachment mechanism of claim 13 wherein the channel is formed between first and second side panels, a base, a back panel, the base and back panel extending between the side panels, and first and second guides attached to the side panels and in spaced relation with the back panel.

20. The attachment mechanism of claim 13 further comprising one or more keyways cut into the base of the adapter to releasably receive one or more keys extending from a body of an ESL.

21. The attachment mechanism of claim 13 further comprising first and second mounting arms extending upward from the base and side panels, the first and second mounting arms each including a latch to engage first and second catches formed in a body of an ESL.
